(19) United States
(12) Patent Application Publication
(10) Pub. No.: US 2022/0371071 A1
(43) Pub. Date: Nov. 24, 2022

(54) VALUE STREAM PROCESS FOR ROLL FORMING AND BOBBIN TOOL FRICTION STIR WELDING ALUMINUM SHEET TO FORM VEHICLE STRUCTURAL RAILS

(71) Applicant: Ford Global Technologies, LLC, Dearborn, MI (US)

(72) Inventors: Daniel Scott Freiberg, Dearborn, MI (US); Elizabeth Therese Hetrick, Ann Arbor, MI (US); Michael Herbert Oelscher, Bergheim (DE); Andrey M. Ilinich, Novi, MI (US); David John Hill, Ann Arbor, MI (US)

(73) Assignee: Ford Global Technologies, LLC, Dearborn, MI (US)

(21) Appl. No.: 17/323,322

(22) Filed: May 18, 2021

(51) Int. Cl. B21D 26/033; C22F 1/04; B23K 20/12

(52) U.S. Cl. CPC B21D 26/033; C22F 1/04; B23K 20/122; B23K 2101/006

(57) ABSTRACT

A value stream method of manufacturing a plurality of vehicle structural rails includes feeding a coil of aluminum alloy sheet into a roll forming machine and forming a tubular shape with a seam, bobbin tool-friction stir welding the seam of the tubular shape and forming a welded tubular shape with a welded seam, cutting the welded tubular shape into a plurality of tubular sections, tube bending each of the plurality of tubular sections and forming a plurality of bent tubular sections, and hydroforming each of the plurality of bent tubular sections and forming a plurality of structural rails. The coil of aluminum alloy sheet may or may not be pre-treated and/or lubricated.

### FIELD

The present disclosure relates to structural rails, and particularly to methods of forming structural rails for vehicles.

### BACKGROUND

The statements in this section merely provide background information related to the present disclosure and may not constitute prior art.

The use of aluminum alloys in motor vehicles assists automotive manufacturers in meeting emission reduction and fuel economy goals. For example, some vehicles include structural rails (e.g., roof rails) formed from extruded 6000 series structural aluminum alloy tubes. However, factors such as alloy selection, billet heating, die design, die lubrication, and extrusion process parameters can affect the microstructure and cost of such extruded structural aluminum alloy tubes.

The present disclosure addresses issues of structural aluminum alloy tubes, among other issues related to structural rails.

### SUMMARY

This section provides a general summary of the disclosure and is not a comprehensive disclosure of its full scope or all of its features.

In one form of the present disclosure, a value stream method of manufacturing a plurality of vehicle structural rails includes uncoiling a coil of aluminum alloy sheet and feeding the aluminum alloy sheet into a roll forming machine and forming a tubular shape with a seam, bobbin tool-friction stir welding (BT-FSW) the seam of the tubular shape and forming a welded tubular shape with a welded seam, cutting the welded tubular shape into a plurality of tubular sections, tube bending each of the plurality of tubular sections and forming a plurality of bent tubular sections, and hydroforming each of the plurality of bent tubular sections and forming a plurality of structural rails.

In some variations the method further includes feeding the aluminum alloy sheet into a surface pre-treatment system and forming a pre-treated aluminum alloy sheet before feeding the pre-treated aluminum alloy sheet into the roll forming machine and forming the tubular shape with the seam.

In at least one variation, the method further includes feeding the aluminum alloy sheet into a lubricant system and forming a lubricated aluminum alloy sheet before feeding the lubricated aluminum alloy sheet into the roll forming machine and forming the tubular shape with the seam.

And in some variations, the method further includes feeding the aluminum alloy sheet into a surface pre-treatment system and into a lubricant system, and feeding the aluminum alloy sheet that is pre-treated and lubricated into the roll forming machine and forming the tubular shape with the seam.

In at least one variation, tube bending each of the plurality of tubular sections includes automatically locating the welded seam of each of the plurality of tubular sections, placing each of the plurality of tubular sections into a rotary-draw bending machine such that the welded seam has a predetermined orientation within the rotary-draw bending machine, and tube bending each of the plurality of tubular sections to form the plurality of bent tubular sections. In such variations, hydroforming each of the plurality of bent tubular sections can include placing each of the plurality of bent tubular sections into a hydroforming machine and hydroforming each of the bent tubular sections to form the plurality of structural rails.

In some variations, the method includes pre-forming each of the plurality of bent tubular sections and forming a plurality of pre-formed tubular sections before hydroforming each of the plurality of bent tubular sections. And in such variations the method can include locally induction heat treating each of the plurality of bent tubular sections before pre-forming each of the plurality of bent tubular sections and/or locally induction heat treating each of the plurality of pre-formed tubular sections after preforming each of the plurality of bent tubular sections.

In at least one variation, tube bending each of the plurality of tubular sections includes rotary-draw bending each of the plurality of tubular sections.

In some variations, the method further includes trimming each of the plurality of structural rails before artificial aging the plurality of structural rails.

In at least one variation, the aluminum alloy sheet is a 6xxx series aluminum alloy and the method includes artificial aging each of the plurality of structural rails with a T6 heat treatment such as heat treatment at 170-250° C. for 0.5-8.0 hours, automotive paint baking at 160-200° C. for 10-30 minutes, among others.

In other variations, the aluminum alloy sheet is an 7xxx series aluminum alloy and the method includes artificial aging each of the plurality of structural rails. In such variations, at least a portion of the artificial aging of the plurality of structural rails includes automotive paint baking the plurality of structural rails.

In some variations, the aluminum alloy sheet is an AA6111 aluminum alloy and the method includes artificial aging each of the plurality of structural rails. In such variations, each of the plurality of artificially aged structural rails has a yield strength of at least 350 MPa.

In at least one variation, the method includes feeding the aluminum alloy sheet into a surface pre-treatment system and forming a pre-treated sheet, feeding the pre-treated sheet into a lubrication system and applying lubrication to the pre-treated sheet and forming a pre-treated lubricated sheet, feeding the pre-treated lubricated sheet into the roll forming machine and forming the tubular shape with the BT-FSW′d seam, locally induction heat treating the plurality of bent tubular sections and forming a plurality of recovered bent tubes, and locally induction heat treating each of the plurality of pre-formed tubular sections and forming a plurality of recovered pre-formed tubular sections.

In another form of the present disclosure, a method of manufacturing a plurality of vehicle structural rails includes uncoiling a coil of aluminum alloy sheet made from a 6xxx series aluminum alloy, feeding the aluminum alloy sheet into a surface pre-treatment system, and feeding the pre-treated sheet into a forming lubrication system and applying lubrication to the pre-treated sheet and forming a pre-treated lubricated sheet, feeding the pre-treated lubricated sheet into a roll forming machine and forming a tubular shape with a seam, BT-FSW the seam of the tubular shape and forming a welded tubular shape with a welded seam, cutting the welded tubular shape into a plurality of tubular sections, tube bending each of the plurality of tubular sections and forming a plurality of bent tubular sections, locally induction heat treating the plurality of bent tubular sections and forming a plurality of recovered bent tubes, pre-forming each of the plurality of recovered bent tubes and forming a plurality of pre-formed tubular sections, locally induction heat treating each of the plurality of pre-formed tubular sections and forming a plurality of recovered pre-formed tubular sections, hydroforming each of the plurality of recovered pre-formed tubular sections and forming a plurality of structural rails, and trimming the plurality of structural rails and forming a plurality of trimmed structural rails.

In some variations, the method further includes artificial aging each of the plurality of structural rails with a T6 heat treatment such as heat treatment at 170-250° C. for 0.5-8.0 hours, automotive paint baking at 160-200° C. for 10-30 minutes, among others.

In at least one variation, tube bending each of the plurality of tubular sections includes automatically locating the welded seam of each of the plurality of tubular sections, placing each of the plurality of tubular sections in a tube bending machine with the welded seam having a predetermined orientation within the tube bending machine, and tube bending each of the plurality of tubular sections to form the plurality of bent tubular sections.

In still another form of the present disclosure, a method of manufacturing a plurality of vehicle structural rails includes uncoiling a coil of aluminum alloy sheet made from a 7xxx series aluminum alloy, feeding the aluminum alloy sheet into a surface pre-treatment system and forming a pre-treated sheet, feeding the pre-treated sheet into a lubrication system and applying lubrication to the pre-treated sheet and forming a pre-treated lubricated sheet, feeding the pre-treated lubricated sheet into a roll forming machine and forming a tubular shape with a seam, BT-FSW the seam of the tubular shape and forming a welded tubular shape with a welded seam, cutting the welded tubular shape into a plurality of tubular sections, tube bending each of the plurality of tubular sections and forming a plurality of bent tubular sections, locally induction heat treating the plurality of bent tubular sections forming a plurality of recovered bent tubes, pre-forming each of the plurality of recovered bent tubes and forming a plurality of pre-formed tubular sections, locally induction heat treating each of the plurality of pre-formed tubular sections and forming a plurality of recovered pre-formed tubular sections, hydroforming each of the plurality of recovered pre-formed tubular sections and forming a plurality of structural rails, and trimming the plurality of structural rails and forming a plurality of trimmed structural rails.

In some variations, tube bending each of the plurality of tubular sections includes automatically locating the weld seam of each of the plurality of tubular sections, placing each of the plurality of tubular sections into a tube bending machine with the welded seam having a predetermined orientation within the tube bending machine, and tube bending each of the plurality of tubular sections to form the plurality of bent tubular sections.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a flow chart for a value stream method of manufacturing structural rails according to the teachings of the present disclosure;

FIG. 2 is a flow diagram for a value stream method of manufacturing structural rails according to the teachings of the present disclosure;

FIG. 3 is a perspective view of a roll formed tubular shape formed according to the teachings of the present disclosure;

FIG. 4 is an end view of a seam of the roll formed tubular shape in FIG. 3 being bobbin-tool friction stir welded according to the teachings of the present disclosure;

FIG. 5 is a perspective view of the roll formed tubular shape in FIG. 3 with a welded seam formed according to the teachings of the present disclosure;

FIG. 6 is an illustration of a welded seam according to the teachings of the present disclosure;

FIG. 7 is a plan view of rotary-draw bending machine bending a tubular section according to the teachings of the present disclosure;

FIG. 8 is a perspective view of a bent tubular section being locally induction heat treated according to the teachings of the present disclosure;

FIG. 9 is a side view of a recovered bent tubular section according to the teachings of the present disclosure;

FIG. 10A is a cross-sectional view of a recovered bent tubular section positioned between a pair of hydroforming dies;

FIG. 10B is a cross-sectional view of the pair of hydroforming dies in FIG. 10A partially closed around the recovered bent tubular section;

FIG. 10C is a cross-sectional view of the recovered bent tubular section in FIG. 10B filled with liquid under a first pressure;

FIG. 10D is a cross-sectional view of the pair of hydroforming dies in FIG. 10C completely closed around the recovered bent tubular section; and

FIG. 10E is a cross-sectional view of the recovered bent tubular section in FIG. 10D filled with liquid under a second pressure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a method of forming vehicle structural rails out of commercially available aluminum alloy sheet, i.e., sheet made out of a commercially available aluminum sheet alloy. Accordingly, the present disclosure takes advantage of enhanced tolerance, quality, and mechanical properties of commercially available aluminum sheet alloys (and cost savings) compared to aluminum extrusion or aluminum cast alloys.

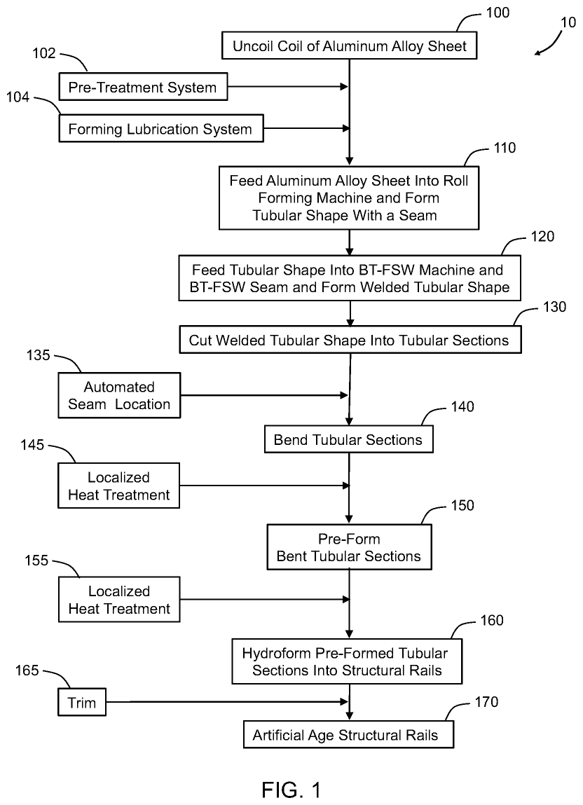

Referring to FIG. 1, a value stream method 10 for forming aluminum structural rails is shown. The value stream method 10 includes uncoiling a coil of aluminum alloy sheet at step 100 and feeding the aluminum alloy sheet into a roll forming machine and roll forming a desired tubular shape with a seam at step 110. As used herein, the phrase “roll forming” refers to a process that includes passing or feeding the aluminum alloy sheet through a plurality of rollers that incrementally and continuously bend the aluminum alloy sheet into a desired cross-section. In some variations the aluminum alloy sheet is fed into a pre-treatment system (e.g., a surface pre-treatment system) at step 102 and/or a lubrication system (e.g., a forming lubrication system) at step 104 such that the surface(s) of the aluminum alloy sheet is pre-treated (e.g., chemically pre-treated) and lubricated before being fed into the roll forming machine at step 110. In some variations, the pre-treatment system provides for a completed aluminum alloy (also referred to herein simply as “aluminum”) structural rail with an enhanced surface for receiving and holding an adhesive, paint, and/or other chemical desired for downstream vehicle assembly processing. And in at least one variation the pre-treatment system provides a generally consistent surface on the aluminum alloy sheet for downstream welding operations.

The desired tubular shape with the seam is fed into a bobbin tool-friction stir welding (BT-FSW) machine at step 120 and the seam is bobbin tool-friction stir welded such that a welded tubular shape with a welded seam is formed. In at least one variation, the value stream method 10 includes a post-weld heat treatment (not labeled) after step 120 such that an increase in the mechanical properties (e.g., ductility) of the desired tubular shape and/or the welded seam is provided. As the welded tubular shape exits the BT-FSW machine, the welded tubular shape is fed into a cutting machine and cut into tubular sections at step 130. In the alternative, the BT-FSW machine includes a cutter and the welded tubular shape is cut into the tubular sections before exiting the BT-FSW machine. Non-limiting examples of a cutting machine and/or a cutter include a laser cutting machine, a band saw cutting machine, a circular saw cutting machine, among others.

The tubular sections are bent (e.g., in a tube bending machine) at step 140 to form bent tubular sections. In some variations, the welded seam of the tubular sections is automatically located at step 135 before the tubular sections are bent. For example, the welded seam is automatically located at step 135 such that the weld seam is positioned and/or oriented at a desired location or position in a tube bending machine before bending of the tubular section at step 140 such that bending/deformation of the welded seam does not exceed a predefined value.

In some variations, the bent tubular sections are subjected to localized heat treatment (e.g., localized induction heat treatment) at step 145 to provide recovery of work hardening during bending of the tubular sections and thereby provide recovered bent tubular sections before being subjected to pre-forming at step 150 to form pre-formed tubular sections. Stated differently, the localized heat treatment recovers some or all of the ductility of the alloy material after being plastically deformed at step 140. In some variations, and similar to step 145, the pre-formed tubular sections are subjected to localized heat treatment at step 155 to provide recovery of work hardening during pre-forming of the bent tubular sections and thereby provide recovered pre-formed tubular sections before being hydroformed to form structural rails at step 160. The structural rails are artificially aged at step 170 to provide vehicle structural rails, and in some variations the structural rails are trimmed at step 165 to provide trimmed vehicle structural rails before being artificially aged at step 170. Non-limiting examples of trimming include cutting the structural rails to a desired length, drilling and/or machining holes and/or other features in the structural rail, among others.

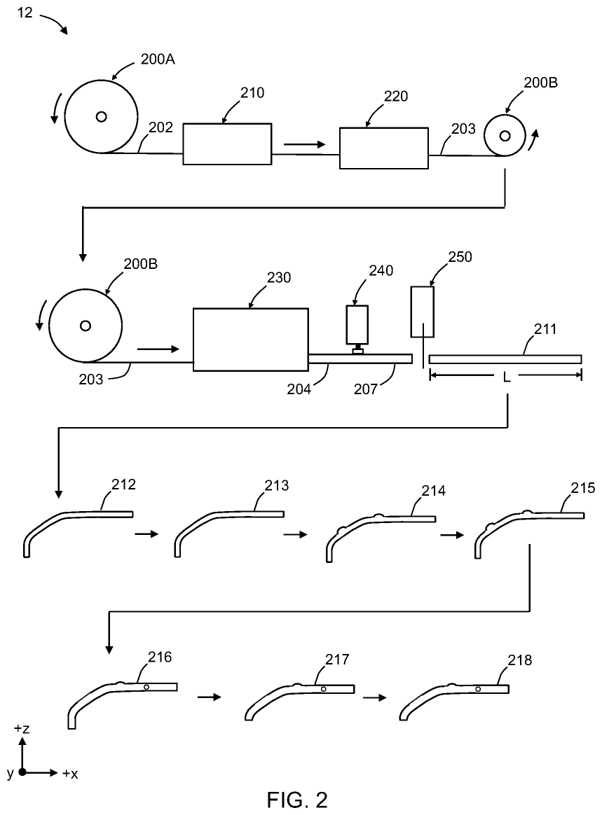

Referring now to FIG. 2, a flow diagram 12 for the value stream method 10 is shown. Particularly, a coil 200A of aluminum alloy sheet 202 is uncoiled and fed through a pre-treatment system 210 and a lubrication system 220 (e.g., a forming lubrication system) to form or provide pre-treated and lubricated aluminum alloy sheet (simply referred to herein as “pre-treated lubricated aluminum alloy sheet” or “pre-treated lubricated sheet”) 203 that is coiled into a coil 200B. In some variations, the coil 200A is a strip of the aluminum alloy sheet 202. That is, a coil (not shown) of aluminum alloy sheet 202 having a first width (y direction) is uncoiled and slit into a plurality of strips (not shown) having one or more second widths less than the first width, and the plurality of strips are recoiled to form or provide one or more coils 200A or one or more coils 200B after pre-treatment and lubrication. And in at least one variation, the width of the coil 200B (i.e., the width of the aluminum alloy strip that has been re-coiled to form the coil 200B) is a desired width for roll forming a desired tubular shape without additional cutting or trimming of the aluminum alloy sheet 202 or the pre-treated lubricated aluminum alloy sheet 203.

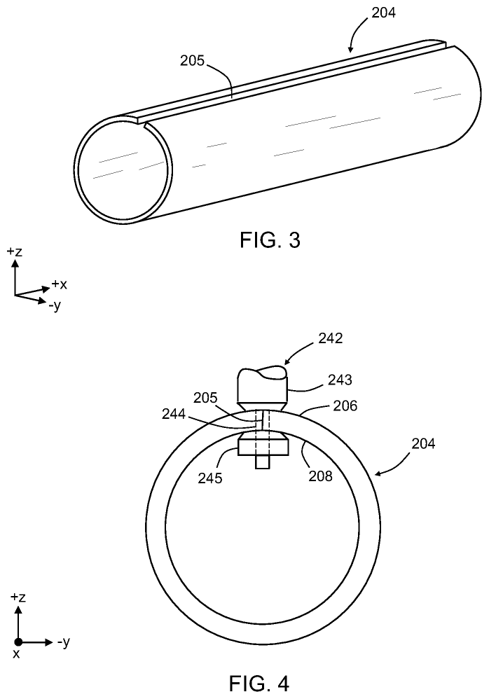

Still referring to FIG. 2, the coil 200B is uncoiled and the pre-treated lubricated aluminum alloy sheet 203 is fed into a roll forming machine 230 and roll formed into a desired tubular shape 204 with a seam 205 (FIG. 3) extending along a length direction (x direction) of the desired tubular shape 204. For example, the roll forming machine 230 can include a plurality of rollers mounted on consecutive stands such that each stand of rollers incrementally bends the pre-treated lubricated aluminum alloy sheet 203 into the desired tubular shape 204 as the aluminum alloy sheet 203 passes through and exits the roll forming machine 230. And while FIG. 3 shows the desired tubular shape 204 as being cylindrical, it should be understood that in some variations the desired tubular shape 204 is not cylindrical. Also, in some variations the desired tubular shape 204 is not cylindrical but is symmetric about a plane (e.g., a y-z plane shown in FIG. 3) extending along the length direction of the desired tubular shape 204, while in other variations the desired tubular shape 204 is not cylindrical and is asymmetric about a plane extending along the length direction of the desired tubular shape 204.

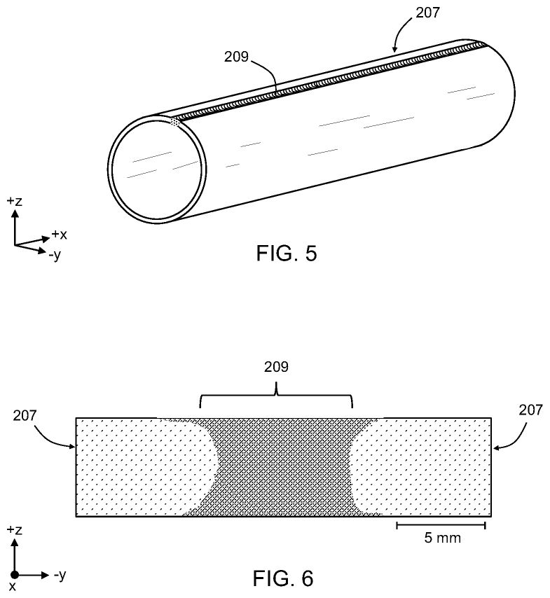

The desired tubular shape 204 with the seam 205 is fed into a bobbin tool-friction stir welding (BT-FSW) machine 240 and the seam 205 is bobbin tool-friction stir welded (FIG. 4) such that a welded tubular shape 207 with a welded seam 209 is formed (FIG. 5). As shown in FIG. 4, BT-FSW includes use of a bobbin tool 242 with an upper shoulder 243 and lower shoulder 245 connected or coupled together with a tool pin 244. The tool pin 244 rotates and is traversed along the seam 205 and through the desired tubular shape 204 such that a local region of heated and highly plasticized material around or proximal to the tool pin 244 is produced. Also, an outer surface 206 and an inner surface 208 of the desired tubular shape 204 proximal to the seam 205 are constrained by the upper shoulder 243 and lower shoulder 245, respectively, and the heated and highly plasticized material around or proximal to the tool pin 244 intermixes such that the welded seam 209 is formed as shown in FIGS. 5 and 6.

In some variations of the present disclosure, the BT-FSW process is a counter-rotating shoulder BT-FSW process in which the upper shoulder 243 rotates in a first direction and the lower shoulder 245 rotates in a second direction opposite the first direction. For example, and with reference to FIG. 4, the upper shoulder 243 rotates in a clockwise direction or a counter-clockwise direction when viewed along the −z direction and the lower shoulder 245 rotates in a counter-clockwise direction or a clockwise direction, respectively, when viewed along the −z direction. In other variations, the BT-FSW process is a differential rotation shoulder BT-FSW process in which the upper shoulder 243 rotates in a first direction at a first revolutions per minute (RPM) and the lower shoulder 245 rotates in the first direction at a second RPM that is different than the first RPM. In still other variations, the BT-FSW process is a semi-stationary shoulder BT-FSW process in which the upper shoulder 243 rotates and the lower shoulder 245 does not rotate, or in the alternative, the upper shoulder 243 does not rotate and the lower shoulder 245 rotates. In still yet other variations, the BT-FSW process is a stationary shoulder BT-FSW process in which only the tool pin 244 rotates, i.e., the upper shoulder 243 and the lower shoulder 245 do not rotate. And in at least one variation of the present disclosure, the BT-FSW process is a conventional shoulder BT-FSW process in which the upper shoulder 243 and the lower shoulder 245 rotate in the same direction and at the same RPM.

Still referring to FIG. 2, as the welded tubular shape 207 exits the BT-FSW machine 240, the welded tubular shape 207 is fed into a cutting machine 250 and cut into a plurality of tubular sections 211 with desired lengths ‘L’. In the alternative, the BT-FSW machine 240 includes the cutting machine 250 (i.e., a cutter) and the welded tubular shape 207 is cut into the plurality of tubular sections 211 before exiting the BT-FSW machine 240.

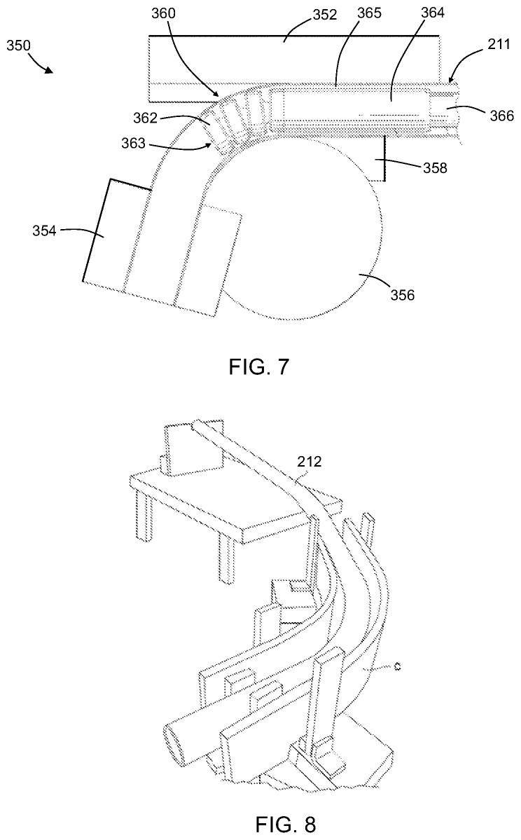

The tubular sections 211 are bent to form bent tubular sections 212. In some variations the tubular sections 211 are bent using a rotary-draw bending operation with a mandrel and galling-resistive inserts as disclosed in U.S. Pat. No. 10,086,422 which is incorporated in the present disclosure by reference. For example, and with reference to FIG. 7, a rotary-draw bending machine 350 with a follower 352, clamp 354, bending die 356, wiper 358, and a mandrel assembly 360 with a plurality of ball bodies 362 and a shank 364 connected to a rod 366 is shown. During operation (i.e., bending of the tubular section 211), the leading end or edge of a tubular section 211 is clamped via clamp 354 to bending die 356 and the mandrel assembly 360 is placed within the tubular section 211. Particularly, outer surfaces 363 of the plurality of ball bodies 362 and an outer surface 365 of a shank body 364 are generally shaped to fit within the tubular section 211 with a desired clearance fit such that the outer surfaces 363 and the outer surface 365 contact the inner surface 208 (FIG. 4) of the tubular section 211 during the bending process. And as the bending die 356 rotates and draws the tubular section 211 around the bending die 356, the inner surface 208 of the tubular section 211 is supported by the mandrel assembly 360 and the outer surface 206 of the tubular section 211 is supported by the follower 352 and the wiper 358. Accordingly, the mandrel assembly 360 inhibits tube buckling, wrinkling, and collapse of the tubular section 211 during the bending operation. And while bending with a mandrel has been described, it should be appreciated that “empty bending” without a mandrel may also be utilized in the overall method.

In some variations, the welded seam 209 is automatically located before the tubular section 211 is bent. In at least one variation, the welded seam 209 is automatically located and positioned and/or oriented at a desired location or position relative to the rotary-draw bending machine 350 such that the impact to downstream joining operations is minimized. And in some variations the welded seam 209 is automatically located and positioned and/or oriented at a desired location or position relative to the rotary-draw bending machine 350 such that bending/deformation of the welded seam 209 does not exceed a predefined value during forming of the bent tubular sections 212. For example, in at least one variation the welded seam 209 is located at a top dead center or a bottom dead center of the tubular section being bent in FIG. 7 such that the welded seam 209 is subjected to a minimal strain during the bending process. That is, it should be understood that the outer surface 206 (FIG. 4) of the tubular section 211 touching or in contact with the bending die 356 experiences or is subjected to the maximum compressive strain during the bending process, the outer surface 206 of the tubular section 211 that is 180 degrees from the surface touching or in contact with the bending die 356 experiences or is subjected to the maximum tensile strain during the bending process, and the outer surface 206 of the tubular section that is +90 degrees and −90 degrees from the outer surface 206 touching or in contact with the bending die 356 experiences or is subjected to a minimal strain during the bending process.

As noted above, in some variations, the bent tubular sections 212 are subjected to localized heat treatment to provide recovery of work hardening during bending of the tubular sections 211. For example, and with reference to FIG. 8, in some variations the bent tubular sections 212 are positioned in a water-cooled copper “channel” coil C that follows or is generally the same shape as a bent tubular section 212. Also, the channel coil C forms a transformer primary, the bent tubular section 212 forms a transformer secondary, and an electromagnetic alternating field is provided and flows through the channel coil C such that localized heating at desired locations or areas of the bent tubular section 212 is provided. Stated differently, localized induction heat treatment (also known as “induction annealing”) of the bent tubular section 212 is provided.

In some variations, the aluminum alloy sheet 202 is a 6xxx series aluminum alloy sheet and the induction heat treatment is completed at a temperature of between 120-160° C. utilizing a 10-30 second ramp time, for example the induction heat treatment is completed at a temperature of 130-150° C. utilizing a ramp time of 20-30 seconds, at a temperature of 135-145° C. utilizing a ramp time of 20-30 seconds, or at a temperature of about 140° C. utilizing a ramp time of 25-30 seconds. In other variations, the aluminum alloy sheet 202 is a 7xxx series aluminum alloy sheet and the induction heat treatment includes heating to a temperature between 180-260° C. utilizing a ramp time of 10-30 seconds, cooling, and heating to a temperature between 345-410° C. utilizing a ramp time of 10-30 seconds.

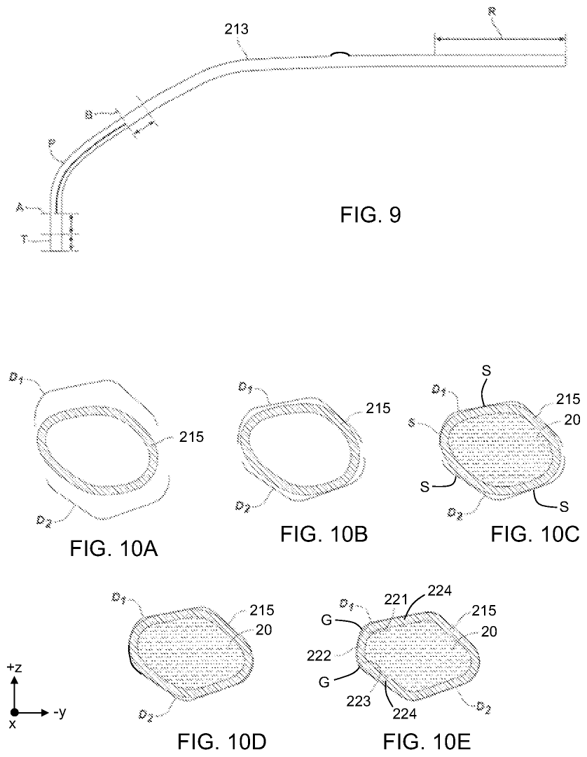

Referring to FIG. 9, one example of a recovered bent tubular section 213 with an A-pillar portion ‘P’ where induction heat treatment has been completed from point A to point B is shown. Also, a portion ‘T’ of the recovered bent tubular section 213 is trimmed during the process as will be described in greater detail below. It should be understood that a roof rail portion ‘R’ of the recovered bent tubular section 213 may be of different lengths depending upon the body style of the vehicle (e.g. regular cab, extended cab, crew cab).

Still referring to FIG. 2, the recovered bent tubular sections 213 are pre-formed to form pre-formed tubular sections 214, and in some variations, the pre-formed tubular sections 214 are subjected to localized heat treatment as described above to provide recovery of work hardening during pre-forming (i.e., to provide recovered pre-formed tubular sections 215) before being hydroformed to provide structural rails 216. For example, and with reference to FIGS. 10A-10E, in some variations the recovered pre-formed tubular sections 215 are loaded into a hydroforming die which is illustrated as a two dies D1, D2 in FIG. 10A. In some variations, the recovered pre-formed tubular sections 215 are loaded into or between the dies D1, D2 with the welded seam 209 (not shown in FIGS. 10A-10E) located and positioned and/or oriented at a desired location or position relative to the dies D1, D2. However, in other variations the recovered pre-formed tubular sections 215 have a predefined shape such that orientation of the welded seam 209 is set or predefined prior to bending of the tubular sections 211 and/or prior to loading the recovered pre-formed tubular sections 215 into or between the dies D1, D2.

Following loading of a recovered pre-formed tubular section 215 into the dies D1, D2, the dies D1, D2 are partially closed as shown in FIG. 10B and a liquid 20 with a first pressure is introduced into the interior of the recovered pre-formed tubular sections 215 as shown in FIG. 10C. In some variations, the first pressure is within the range of approximately 0 to 200 bar, for example within the range of 50 to 150 bar. In at least one variation the first pressure is approximately 100 bar. Also, it should be understood that hydroforming liquid 20 may be water or some other appropriate liquid.

As shown in FIG. 10C, the dies D1, D2 include one or more flat nose wall sections S shaped to make contact with the recovered pre-formed tubular sections 215 when the dies D1, D2 are only partially closed and the first pressure is being applied to prevent the tube from collapsing during a closeout stage. These points of contact form intermediate sections of a flat nose corner radius of a structural rail 216 and reduces the amount of circumferential outer fiber strain and ductility needed to form the recovered pre-formed tubular sections 215 into a structural rail 216.

The hydroforming dies D1, D2 are completely closed around the recovered pre-formed tubular sections 215 as shown in FIG. 10D and the pressure of the liquid 20 filling the recovered pre-formed tubular sections 215 is increased to a second pressure to form, and in some variations hydro-pierce, the structural rail 216. In some variations, the second pressure is within the range of 500 to 1500 bar, for example within the range of 750 to 1250 bar. In at least one variation the second pressure is approximately 1000 bar.

As the pressure of the liquid 20 within the recovered pre-formed tubular sections 215 is increased, the recovered pre-formed tubular sections 215 are pressed outwardly toward the dies D1, D2. The intermediate section of the flat nose corner radius is already in engagement with the flat nose wall sections S of the dies D1, D2 before the pressure of the liquid 20 is increased to the second pressure and this prevents unrestricted/unsupported cross-sectional bending during the closeout. In contrast, conventional hydroforming does not include contact of a workpiece with die walls until the dies are fully closed and calibration pressure is applied.

The engagement of the recovered pre-formed tubular sections 215 with the wall sections S of the dies D1, D2 provides a slight gap G between the dies D1, D2 and the recovered pre-formed tubular sections 215 as shown in FIG. 10E, and thereby results in forming of a first transition segment 221 and a second transition segment 223 between a curved section 222 and a flat section 224 of the structural rail 216. The hydroformed structural rail 216 is trimmed to a final desired length by means of laser trimming or other appropriate trimming operation. For example, the portion ‘T’ shown in FIG. 9 is trimmed (removed) from the structural rail 216, and in some variations a length of the roof rail portion R shown in FIG. 9 can be trimmed such that a trimmed structural rail 217 is provided.

In some variations, the trimmed structural rail 217 is artificially aged to a desired strength to provide a vehicle structural rail 218. And in at least one variation, a plurality of trimmed structural rails 217 are assembled on a multipurpose rack before being artificial aged.

In some variations, the aluminum alloy sheet is a 6xxx series alloy (e.g., the AA6111 alloy) and the aluminum alloy sheet 202 or the pre-treated lubricated aluminum alloy sheet 203 (simply referred to herein as “aluminum alloy sheet 202, 203”) is provided in a T4 temper condition (i.e., the aluminum alloy sheet 202, 203 is subjected to a “T4 heat treatment” such as a solution heat treatment on a continuous anneal line followed by natural aging) and the aluminum alloy sheet 202, 203 is roll formed, bobbin-tool friction stir welded, bent and hydroformed in the T4 temper condition to form the plurality of structural rails 216, which are trimmed and then batch heat treated between 170-250° C. for 0.5-0.8 hours to provide a plurality of vehicle structural rails in a T6 temper condition. In at least one variation, the 6xxx series alloy is the AA6111 alloy and the T6 heat treatment is 1 hour at 225° C.

In other variations, the aluminum alloy sheet is a 6xxx series alloy and the aluminum alloy sheet 202 or the pre-treated lubricated aluminum alloy sheet 203 is provided in a T4 temper condition and the aluminum alloy sheet 202, 203 is roll formed, bobbin-tool friction stir welded, bent and hydroformed in the T4 temper condition to form the plurality of structural rails 216, which are trimmed and then subjected to an automotive paint bake process to achieve near peak-age strength. In some variations, the paint bake process is at 160-200° C. for 10-30 minutes.

In other variations, the aluminum alloy sheet is a 6xxx series alloy and a coil of the aluminum alloy sheet 202, 203 is provided in a stabilized/pre-aged condition (e.g., solution heat treated, quenched and stabilized using low temperature such as 60° C.-120° C.). Then the aluminum alloy sheet 202, 203 in the stabilized/pre-aged condition is roll formed, bobbin-tool friction stir welded, bent and hydroformed to form the plurality of structural rails 216, which are trimmed and then subjected to an automotive paint bake process. It should be understood that stabilization/pre-aging minimizes natural aging or change in strength of the aluminum alloy sheet 202, 203 during subsequent room temperature storage and enhances the subsequent paint bake response of the material.

In still other variations, the aluminum alloy sheet is a 6xxx series alloy and a coil of the aluminum alloy sheet 202, 203 is provided in a T6 temper condition and the aluminum alloy sheet 202, 203 in the T6 temper condition is roll formed, bobbin-tool friction stir welded, bent and hydroformed to form a plurality of structural rails 216, which are trimmed and then subjected to an automotive paint bake process. In some variations, the T6 heat treatment is a batch heat treatment of the coil of the aluminum alloy sheet 202, 203 at temperature(s) between 170-250° C. for 0.5-8.0 hours. In at least one variation, the 6xxx series alloy is the AA6111 alloy and the T6 heat treatment is 1 hour at 225° C.

In some variations, the aluminum alloy sheet is a 7xxx series alloy (e.g., the AA7075 alloy) and the aluminum alloy sheet 202, 203 is provided in a T4 temper condition and the aluminum alloy sheet 202, 203 in the T4 temper condition is roll formed, bobbin-tool friction stir welded, bent and hydroformed to form a plurality of structural rails 216, which are then trimmed and batch annealed with a one-step or a two-step T6 heat treatment to provide a plurality of vehicle structural rails 218. In at least one variation, the one-step heat treatment includes heat treatment between 100-200° C. for 1-24 hours. Regarding the two-step T6 temper condition, in some variations, the two-step heat treatment includes a first step at a temperature(s) between 70-120° C. for 0.5-6.0 hours followed by a second step at a temperature(s) between 120-200° C. for 0.5-6.0 hours. In another variation, the two-step heat treatment includes a first step at a temperature(s) between 100-150° C. for 0.2-3.0 hours followed by a second step at a temperature(s) between 150-185° C. for 0.5-5.0 hours. And in at least one variation the two-step heat treatment includes a first step at 110° C. for 2.0 hours followed by a second step at 165° C. for 2.0 hours.

In other variations, the aluminum alloy sheet is a 7xxx series alloy and the aluminum alloy sheet 202, 203 is provided in a stabilized/pre-aged condition and roll formed, bobbin-tool friction stir welded, bent and hydroformed to form a plurality of structural rails 216 which are trimmed and installed on vehicles and subjected to an automotive paint bake process to provide a T6 heat treatment and achieve near peak-age strength.

In still other variations, the aluminum alloy sheet is a 7xxx series alloy and the aluminum alloy sheet 202, 203 is provided in a T4 temper condition and the aluminum alloy sheet 202, 203 in the T4 temper condition is roll formed, bobbin-tool friction stir welded, bent and hydroformed to form the plurality of structural rails 216, which are then trimmed and batch annealed to a stabilized/pre-aged condition, and then installed on vehicles and subjected to an automotive paint bake process to provide a T6 heat treatment.

And in still yet other variations, the aluminum alloy sheet is a 7xxx series alloy and a coil of the aluminum alloy sheet 202, 203 is provided in the T6 temper condition. Then the aluminum alloy sheet 202, 203 in the T6 temper condition is roll formed, bobbin-tool friction stir welded, bent and hydroformed to form the plurality of structural rails 216, which are trimmed to provide the plurality of vehicle structural rails 218 in the T6 temper condition.

It should be understood that from the teachings of the present disclosure, a method of forming vehicle structural rails from commercially available aluminum sheet alloys provides cost savings compared to traditional methods for forming vehicle structural rails. For example, pre-treating the aluminum alloy sheet in a continuous pre-treatment system prior to roll forming, bending and hydroforming the aluminum alloy sheet, in contrast to batch pre-treatment of the vehicle structural rails provides enhanced efficiency and reduced energy and cost. Also, lubricating the aluminum alloy sheet in a continuous lubrication system prior to roll forming, bending and hydroforming the aluminum alloy sheet, in contrast to batch lubrication of extruded tubes before bending and hydroforming, provides enhanced efficiency and reduced energy and cost. In addition, using coils of aluminum alloy sheet (strip) with a width that is needed to form the tubular sections and vehicle structural rails reduces scrap and costs of the vehicle structural rails.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of manufacturing a plurality of vehicle structural rails, the method comprising:
uncoiling a coil of aluminum alloy sheet and feeding the aluminum alloy sheet into a roll forming machine and forming a tubular shape with a seam;
bobbin tool-friction stir welding (BT-FSW) the seam of the tubular shape and forming a welded tubular shape with a welded seam;
cutting the welded tubular shape into a plurality of tubular sections;
tube bending each of the plurality of tubular sections and forming a plurality of bent tubular sections; and
hydroforming each of the plurality of bent tubular sections and forming a plurality of structural rails.

2. The method according to claim 1 further comprising feeding the aluminum alloy sheet into a continuous surface pre-treatment system and forming a pre-treated aluminum alloy sheet before feeding the pre-treated aluminum alloy sheet into the roll forming machine and forming the tubular shape with the seam.

3. The method according to claim 1 further comprising feeding the aluminum alloy sheet into a forming lubricant system and forming a lubricated aluminum alloy sheet before feeding the aluminum alloy sheet into the roll forming machine and forming the tubular shape with the seam.

4. The method according to claim 1 further comprising feeding the aluminum alloy sheet into a surface pre-treatment system and into a forming lubricant system, and feeding the aluminum alloy sheet that is pre-treated and lubricated into the roll forming machine and forming the tubular shape with the seam.

5. The method according to claim 1, wherein the tube bending each of the plurality of tubular sections comprises automatically locating the welded seam of each of the plurality of tubular sections, placing each of the plurality of tubular sections into a rotary-draw bending machine such that the welded seam has a predetermined orientation within the rotary-draw bending machine, and tube bending each of the plurality of tubular sections to form the plurality of bent tubular sections.

6. The method according to claim 5, wherein the hydroforming each of the plurality of bent tubular sections comprises placing each of the plurality of bent tubular sections into a hydroforming machine such that the weld seam is positioned at a predetermined location within the hydroforming machine, and hydroforming each of the bent tubular sections to form the plurality of structural rails.

7. The method according to claim 5 further comprising pre-forming each of the plurality of bent tubular sections and forming a plurality of pre-formed tubular sections before hydroforming each of the plurality of bent tubular sections.

8. The method according to claim 7 further comprising locally induction heat treating each of the plurality of bent tubular sections before pre-forming each of the plurality of bent tubular sections.

9. The method according to claim 8 further comprising locally induction heat treating each of the plurality of pre-formed tubular sections after preforming each of the plurality of bent tubular sections.

10. The method according to claim 1, wherein the tube bending of the plurality of tubular sections comprises rotary-draw bending each of the plurality of tubular sections.

11. The method according to claim 1 further comprising trimming each of the plurality of structural rails before artificial aging the plurality of structural rails.

12. The method according to claim 1, wherein the aluminum alloy sheet is a 6xxx series aluminum alloy and further comprising artificial aging each of the plurality of structural rails at 225° C. for 1 hour.

13. The method according to claim 1, wherein the aluminum alloy sheet is a 7xxx series aluminum alloy, further comprising artificial aging each of the plurality of structural rails, and wherein at least a portion of the artificial aging of the plurality of structural rails comprises automotive paint baking the plurality of structural rails.

14. The method according to claim 1, wherein the aluminum alloy sheet is an AA6111 aluminum alloy, further comprising artificial aging each of the plurality of structural rails, and wherein each of the plurality of artificially aged structural rails has a yield strength of at least 350 MPa.

15. The method according to claim 1 further comprising:
feeding the aluminum alloy sheet into a continuous surface pre-treatment system and forming a pre-treated sheet;
feeding the pre-treated sheet into a forming lubrication system and applying lubrication to the pre-treated sheet and forming a pre-treated lubricated sheet;
feeding the pre-treated lubricated sheet into the roll forming machine and forming the tubular shape with the seam;
locally induction heat treating the plurality of bent tubular sections and forming a plurality of recovered bent tubes; and
locally induction heat treating each of the plurality of pre-formed tubular sections and forming a plurality of recovered pre-formed tubular sections.

16. A method of manufacturing a plurality of vehicle structural rails, the method comprising:
uncoiling a coil of aluminum alloy sheet, wherein the aluminum alloy sheet is a 6xxx series aluminum alloy;
feeding the aluminum alloy sheet into a continuous surface pre-treatment system and forming a pre-treated sheet;
feeding the pre-treated sheet into a forming lubrication system and applying lubrication to the pre-treated sheet and forming a pre-treated lubricated sheet;
feeding the pre-treated lubricated sheet into a roll forming machine and forming a tubular shape with a seam;
bobbin tool-friction stir welding (BT-FSW) the seam of the tubular shape and forming a welded tubular shape with a welded seam;
cutting the welded tubular shape into a plurality of tubular sections;
tube bending each of the plurality of tubular sections and forming a plurality of bent tubular sections;
locally induction heat treating the plurality of bent tubular sections and forming a plurality of recovered bent tubes;
pre-forming each of the plurality of recovered bent tubes and forming a plurality of pre-formed tubular sections;
locally induction heat treating each of the plurality of pre-formed tubular sections and forming a plurality of recovered pre-formed tubular sections;
hydroforming each of the plurality of recovered pre-formed tubular sections and forming a plurality of structural rails; and
trimming the plurality of structural rails and forming a plurality of trimmed structural rails.

17. The method according to claim 16 further comprising artificial aging each of the plurality of structural rails at 225° C. for 1 hour.

18. The method according to claim 16, wherein the tube bending each of the plurality of tubular sections comprises automatically locating the welded seam of each of the plurality of tubular sections, placing each of the plurality of tubular sections in a tube bending machine with the welded seam having a predetermined orientation within the tube bending machine, and tube bending each of the plurality of tubular sections to form the plurality of bent tubular sections.

19. A method of manufacturing a plurality of vehicle structural rails, the method comprising:
uncoiling a coil of aluminum alloy sheet, wherein the aluminum alloy sheet is a 7xxx series aluminum alloy;
feeding the aluminum alloy sheet into a continuous surface pre-treatment system and forming a pre-treated sheet;
feeding the pre-treated sheet into a forming lubrication system and applying lubrication to the pre-treated sheet and forming a pre-treated lubricated sheet;
feeding the pre-treated lubricated sheet into a roll forming machine and forming a tubular shape with a seam;
bobbin tool-friction stir welding (BT-FSW) the seam of the tubular shape and forming a welded tubular shape with a welded seam;
cutting the welded tubular shape into a plurality of tubular sections;
tube bending each of the plurality of tubular sections and forming a plurality of bent tubular sections;
locally induction heat treating the plurality of bent tubular sections forming a plurality of recovered bent tubes;
pre-forming each of the plurality of recovered bent tubes and forming a plurality of pre-formed tubular sections;
locally induction heat treating each of the plurality of pre-formed tubular sections and forming a plurality of recovered pre-formed tubular sections;
hydroforming each of the plurality of recovered pre-formed tubular sections and forming a plurality of structural rails; and
trimming the plurality of structural rails and forming a plurality of trimmed structural rails.

20. The method according to claim 19, wherein the tube bending each of the plurality of tubular sections comprises automatically locating the weld seam of each of the plurality of tubular sections, placing each of the plurality of tubular sections into a tube bending machine with the welded seam having a predetermined orientation within the tube bending machine, and tube bending each of the plurality of tubular sections to form the plurality of bent tubular sections.
